(19) United States
(12) Patent Application Publication
(10) Pub. No.: US 2014/0074714 A1
(43) Pub. Date: Mar. 13, 2014

(54) ATTENDED DISPENSING ENVIRONMENT UTILIZING MOBILE PAYMENT

(71) Applicant: Gilbarco S.r.l., Firenze (IT)

(72) Inventors: Cristian MELONE, Prato (IT); Giovanni CARAPELLI, High Point, NC (US)

(21) Appl. No.: 14/020,181

(22) Filed: Sep. 6, 2013

Related U.S. Application Data
(60) Provisional application No. 61/698,912, filed on Sep. 10, 2012.

(51) Int. Cl. G06Q 20/32

(52) U.S. Cl. CPC G06Q 20/322; G06Q 20/327; G06Q 20/3274; G06Q 20/3278
USPC 705/44; 235/381; 235/494; 235/493; 235/487; 705/39

(57) ABSTRACT

A payment system is provided for attended vending machines allowing customers to initiate mobile payment for goods or services with an attendant handheld. The handheld can generate a transaction identifier based on obtained transaction information related to goods or services dispensed, which can be provided to a mobile payment server. The handheld can render a representation of the transaction identifier for consumption by a mobile device, such as a quick response (QR) code, bar code, near field communication (NFC) field, Bluetooth communication, etc. The mobile device can process the representation to obtain the transaction identifier for initiating payment with the mobile payment server.

### CROSS-REFERENCE TO RELATED APPLICATIONS

The present application claims the benefit of U.S. patent application No. 61/698,912, filed Sep. 10, 2012, and entitled “ATTENDED DISPENSING ENVIRONMENT UTILIZING MOBILE PAYMENT,” the disclosure of which is hereby incorporated by reference as if set forth verbatim herein in its entirety and relied upon for all purposes.

### TECHNICAL FIELD

The subject matter described herein relates generally to a fueling environment or other attended vending environment where goods or services are dispensed. More particularly, subject matter described herein relates to use of a mobile phone or other portable device to effect payment for an attended vending transaction.

### BACKGROUND

Transaction processing within a retail attended fueling environment conventionally includes interaction between a customer and an attendant operating a fuel dispenser. In such environments, after fuel is dispensed to a customer, the attendant requests a post-payment from the customer. In some examples, the attendant can carry a handheld controller to process credit card or other payment methods from the customer based on information regarding the fuel dispensing transaction. The fuel dispenser can provide the information to the handheld electronically by way of a forecourt controller. Such controllers are communicatively coupled to one or more fuel dispensers and other devices, such as the attendant's handheld, a point-of-sale (POS) terminal, etc., and/or can connect to one or more banks (e.g., a payment server thereof) to process post-payment from a customer.

The forecourt controller typically connects to the handhelds via a wireless connection, such as WiFi connection to an associated local area network (LAN) and/or a Bluetooth connection. In addition, the forecourt controller connects to the fuel dispensers via local wiring and to payment servers, loyalty servers, and/or other remote devices via a network such as the Internet. Thus, for example, the forecourt controller can provide information regarding the fuel dispensing of a customer to the handheld of an attendant. The handheld processes payment from the customer by reading a credit card or other form of payment and transmitting the information to the forecourt controller. The forecourt controller accordingly communicates payment information for authorization to the payment server, and approves or rejects the transaction, an indication of which is received by the forecourt controller and transmitted to the handheld.

Various aspects of vending machine systems using mobile devices are disclosed in U.S. Pat. Nos. 8,032,414, 7,574,377, and 7,664,885, incorporated herein by reference for all purposes.

### SUMMARY

The following presents a simplified summary of one or more aspects of the subject matter disclosed herein to provide a basic understanding thereof. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that follows.

Various aspects described herein are directed to processing a payment at an attended vending machine, such as a fuel dispenser at a service station. Attendants at the retail site can operate handhelds for communicating with the vending machines (e.g., fuel dispensers) to process payment for dispensing goods or services, and the handhelds can effectuate payment via mobile devices. In this regard, a handheld can generate a transaction identifier allowing a mobile device to process the transaction identifier to complete payment at the handheld. In one example, the handheld generates a representation of the transaction identifier consumable by the mobile device from the handheld, another device participating with the vending machine in a network, a printout from such devices, and/or the like. The attendant can initiate this process, in one example.

For example, the generated representation can be a visual representation, such as a quick response (QR) code, bar code, a numeric identifier, etc. In another example, the generated representation can include a short-range communication representation, such as a near field communication (NFC) field, a Bluetooth transmission, etc. In either case, the mobile device consumes the transaction identifier by scanning the printed representation, receiving the short-range communication, etc. The mobile device can then acquire the transaction identifier from the representation, and can send the transaction identifier, or information indicated in the transaction identifier, to a remote server to process the mobile payment. The information can include the transaction identifier or other details of the transaction, such as the vendor, purchase amount, etc. The remote server processes payment based on the information, and can provide a status for the payment processing to the mobile device and/or the handheld.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations may denote like elements, and in which:

FIG. 1 is a diagrammatic representation of an aspect of an example system for processing transactions at an attended vending machine.

FIG. 2 is an aspect of an example system for communicating transaction information between a handheld and a mobile device.

FIG. 3 is an aspect of an example system for processing mobile payment with third party authorization.

FIG. 4 is an aspect of an example methodology for providing a transaction identifier representation to a mobile device for initiating mobile payment for the transaction.

FIG. 5 is an aspect of an example methodology for initiating mobile payment for a transaction at an attended vending machine.

FIG. 6 is an aspect of an example methodology for processing mobile payment with third party authorization.

FIG. 7 is a diagrammatic representation showing operational aspects of a system for initiating mobile payments of transactions at attended vending machines.

FIG. 8 is an aspect of an example system in accordance with aspects described herein.

FIG. 9 is an aspect of an example communication environment in accordance with aspects described herein.

### DETAILED DESCRIPTION

Reference will now be made in detail to various aspects, one or more examples of which are illustrated in the accompanying drawings. Each example is provided by way of explanation, and not limitation of the aspects. In fact, it will be apparent to those skilled in the art that modifications and variations can be made in the described aspects without departing from the scope or spirit thereof. For instance, features illustrated or described as part of one example may be used on another example to yield a still further example. Thus, it is intended that the described aspects cover such modifications and variations as come within the scope of the appended claims and their equivalents.

Described herein are various aspects relating to providing payment processing at an attended vending machine by allowing an attendant handheld to produce a representation of transaction information that is consumable by a consumer's mobile device, such as a “smart phone” or tablet computer. The mobile device can thus obtain the transaction information and can initiate a mobile payment for goods or services dispensed at the vending machine based on the transaction identifier. The representation produced by the attendant handheld can include one or more visual representations (e.g., a quick response (QR) code, a bar code, a transaction number, etc.), one or more communicative representations (e.g., a NFC field, radio frequency identifier (RFID) field, a Bluetooth transmission, etc.), and/or the like.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Artificial intelligence based systems (e.g., explicitly and/or implicitly trained classifiers) can be employed in connection with performing inference and/or probabilistic determinations and/or statistical-based determinations in accordance with one or more aspects of the subject matter as described hereinafter. As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for generating higher-level events from a set of events and/or data. Such inference results in the construction of new events or actions from a set of observed events or stored event data, regardless of whether the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines, etc.), for example, can be employed in connection with performing automatic and/or inferred actions in connection with the subject matter.

Furthermore, the subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it is to be appreciated that a carrier wave can be employed to carry computer-readable electronic data such as those used in transmitting and receiving electronic mail or in accessing a network such as the Internet or a local area network (LAN). Of course, those skilled in the art will recognize many modifications can be made to this configuration without departing from the scope or spirit of the subject matter.

Moreover, the term or is intended to mean an inclusive or rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and an as used in this application and the appended claims should generally be construed to mean one or more unless specified otherwise or clear from the context to be directed to a singular form.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

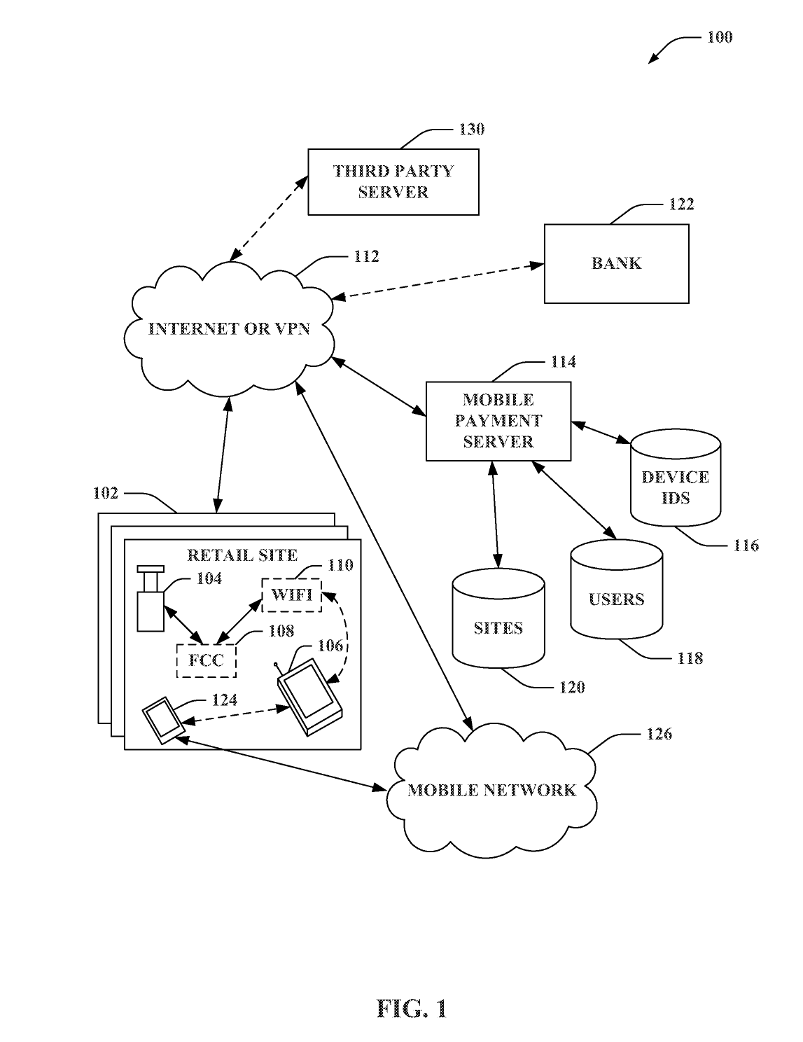

FIG. 1 illustrates an example system 100 for processing mobile payments in a vending environment. System 100 includes one or more retail sites 102, which can each include one or more vending machines 104 (such as a fuel dispenser) and one or more handhelds 106 for processing payment information. In the case of a fueling environment, for example, retail site 102 typically includes a forecourt controller (FCC) 108 for facilitating communication between vending machine 104 and handheld 106 or other components at the retail site. In one example, WiFi 110, which can represent an access point, network switch, router, and/or various other devices to implement a WiFi network, can be used by FCC 108 and handheld 106 to facilitate communication therebetween. In addition, WiFi 110 can provide a wired or wireless connection from retail site 102 to Internet or virtual private network (VPN) 112 for communicating with additional devices. Handheld 106 can additionally or alternatively communicate with vending machine 104 directly via a wireless connection (e.g., WiFi, Bluetooth, ZigBee, etc.). In additional examples, the handheld 106 can be a mobile device (or can include a mobile radio) that communicates with retail site 102 (and vending machine 104) via mobile network 126, Internet 112, etc. Moreover, one or more mobile devices 124 carried by or otherwise associated with a customer can be present at retail site 102. The mobile device(s) 124, which, for example, may be a customer's smart phone or tablet computer, can communicate with Internet 112 via a mobile network 126 and/or WiFi 110.

System 100 also includes a mobile payment server 114 for processing payments initiated by mobile device 124. The mobile payment server 114 can communicate with (and/or provide) multiple databases that store transaction data, such as a device identifier database 116 that stores information regarding a plurality of mobile devices, a users database 118, that stores information regarding mobile device users registered to initiate mobile payments via a mobile device, a sites database 120 that stores information regarding the retail site(s) 102 (e.g., a site identifier, vending machine identifiers, merchant bank information, etc.), and/or other databases. Components of system 100 can communicate with a bank 122 or one or more components thereof, such as a payment server, as well as one or more loyalty servers hosted by the operator of the retail site or a third party host, such as a third party server 130.

In an example, retail site(s) 102 can generate transaction information based on goods or services dispensed by vending machine 104, such as transaction amount, goods or services dispensed, a transaction identifier, and can submit the transaction information to mobile payment server 114 via internet or VPN 112. In this regard, a mobile device 124 can initiate payment at the retail site 102, and can communicate with mobile payment server 114 to complete the transaction based on the information received from retail site 102 as well.

Vending machine 104 can dispense goods or services to a customer. The vending machine 104 can be attended such that an attendant handheld 106 is utilized to authorize operation of the vending machine 104 and to facilitate payment for the goods or services. In one example, the vending machine can be a full service fuel dispenser at a service station attended by one or more attendants that can utilize handheld 106 for communicating with a fuel dispenser as described. The attendant can authorize dispensing at the fuel dispenser via handheld 106 by communicating with the fuel dispenser. In one example, handheld 106 can provide an interface allowing selection of the desired fuel dispenser from among several to authorize dispensing for a given customer. This can initiate a dispensing process for which payment can be subsequently processed as well. Selection of the fuel dispenser by handheld 106 can be effectuated manually, by scanning or otherwise inputting a code displayed on the fuel dispenser, by reading a proximity identifier, such as NFC, RFID, etc., and/or the like.

Thus, the attendant (not shown) can cause the handheld 106 to obtain information regarding the dispensing (e.g., once the fuel dispenser is authorized to dispense), and to generate transaction information for processing payment. The transaction information can include a cost (e.g., a fixed cost or a number of units dispensed along with cost per unit), sales tax information, and/or other information for use in processing payment. In one example, the handheld 106 can allow the attendant to manually enter at least a portion of the transaction information (e.g., where the fuel dispenser is not equipped to communicate such to the handheld 106). The handheld 106 can also generate a transaction identifier for associating with the transaction. The transaction identifier can be unique for the transaction (e.g., for the vending machine 104, retail site 102, and customer accessing such), unique to the vending machine 104 within retail site 102, and/or the like.

In one example, handheld 106 can cause the transaction information to be delivered from the retail site 102 to the mobile payment server 114 for subsequently processing mobile payment from a mobile device 124. In this regard, handheld 106 can utilize WiFi 110 connection to the Internet or VPN 112 to communicate the information to the mobile payment server 114. In other examples, handheld 106 can communicate the information through other devices at the service station, such as a separate point-of-sale (POS) terminal (not shown) that communicates with handheld 106 via FCC 108 or other wired or wireless connections, and also communicates with Internet or VPN 112. In yet other examples, the transaction identifier can identify the retail site 102, vending machine 104, and/or other information that the mobile payment server 114 can use to obtain remaining transaction information from the retail site 102, vending machine 104, etc. once engaged by mobile device 124 for initiating payment. For example, the mobile device 124 can include the transaction identifier in a payment initiation request to the mobile payment server 114.

The mobile payment server 114 can receive a payment initiation request from mobile device 124, and can process the payment based on correlating a transaction identifier with a retail site 102 and/or a related vending machine 104. In one example, this can include correlating the transaction identifier received from mobile device 124 with a transaction identifier previously received from the vending machine 104 or handheld 106 operating the vending machine (e.g., via WiFi at the retail site 102 over Internet 102). The mobile payment server 114 can accordingly determine transaction information based on obtaining transaction information received with the matching transaction identifier from the vending machine 104 or handheld 106. In another example, where the transaction identifier received from mobile device 124 identifies the vending machine 104, mobile payment server 114 can request the transaction information from the identified vending machine 104. In either case, mobile payment server 114 can communicate with bank 122 to approve payment for the transaction. In one example, mobile payment server 114 can communicate a confirmation or rejection for the transaction to vending machine 104 via Internet or VPN 112, which can be forwarded to handheld 106 or other devices at the retail site 102 via WiFi 110.

In another example, a third party server 130 can be employed to provide another layer of authorization for a mobile payment. In this example, mobile payment server 114 can obtain instructions to contact third party server 130 for payments initiated by certain mobile devices. The instructions can be tied to the mobile device identifier stored by mobile payment server 114 (e.g., IDs in device IDs database 116), or otherwise specified by handheld 106 based on information received during transaction or payment processing, such as a mobile device identifier, a mobile device type, an indication from the mobile device upon obtaining the transaction identifier (e.g., a credit card or credit card type used during transaction processing), etc. In any case, mobile payment server 114 can provide transaction information to the third party server 130 based on related instructions, and the third party server 130 can approve or deny the transaction, or provide additional information, such as a payment limit, approval expiration time, etc.

In this example, third party server 130 can be a corporate server that allows for manual approval/denial of transactions on company mobile devices 124 or mobile devices initiating payments using company credit cards. The manual approval can include presenting transaction information from the third party server 130 to an interface or other devices with which the server 130 can communicate, such as one or more computers on a LAN, one or more mobile devices via Internet 112 and mobile network 126, etc. In other examples, the third party server 130 can allow for parental approval of transactions from their children's mobile devices. For example, third party server 130 can push transaction information to a parental mobile device for approval/denial.

In other examples, the third party server 130 can also allow programs to interface therewith for automated approval/denial of transactions. For example, a program on a corporate server can receive transaction information from third party server 130, and can approve or deny the transaction based on additional factors, such as time of day, day of week, location of retail site 102 or mobile device 124, etc., to validate the transaction according to one or more corporate policies. In addition, mobile payment server 114 can contact the third party server 130 for approval as part of a prepayment and/or post-payment process, as described. In one example, though retail site 102 may typically use post-payment processing, handheld 106 can present the option for a pre-authorization with third party server 130 before vending machine 104 dispensing. In this example, mobile device 124 can communicate information regarding pre-authorization to handheld 106 (e.g., via QR code, bar code, NFC field, Bluetooth, etc.), and handheld 106 can pre-authorize mobile device 124 for the transaction (e.g., via mobile payment server 114 communicating with third party server 130 or third party server 130 directly). In one example, third party server 130 can communicate a pre-approval maximum amount for the transaction back to handheld 106 or mobile payment server 114.

In one example, to facilitate mobile payment initiation at mobile device 124, handheld 106 and/or FCC 108 can provide the transaction identifier to a mobile device, such as mobile device 124, in a consumable format. For example, handheld 106 can generate a readable representation of the transaction identifier, such as a QR code, bar code, numeric identifier, and/or the like. In another example, handheld 106 can generate a communicative representation of the transaction identifier, such as a NFC field, Bluetooth or other wireless transmission, etc. In any case, the mobile device 124 can obtain and process the representation, as described further herein, and can accordingly initiate mobile payment based on a related transaction identifier.

In a further example, handheld 106 and mobile device 124 can establish a wireless connection (e.g., over which handheld 106 can transmit the communicative representation of the transaction identifier). For example, the wireless communication can include a NFC connection via an NFC field, a Bluetooth connection, etc. In this example, mobile device 124 can communicate with mobile payment server 114 over the wireless connection with handheld 106 so as not to use resource of the mobile device 124 for such communication. This can be beneficial to a user of the mobile device 124, as can mobile device 124 communicating with WiFi 110 as described, because many mobile service providers limit bandwidth for communicating over mobile network 126. In this example, mobile device 124 transmits data related to initiating mobile payment, as described, which traverses handheld 106 to reach Internet or VPN 112 and on to mobile payment server 114; this can include handheld 106 traversing WiFi 110 or other Internet connections at retail site 102.

In an example, handheld 106 can include the mobile payment server 114 functionality to mitigate the need for a separate server and related communication. Thus, handheld 106 can communicate with the one or more banks 122 directly (or through one or more intermediate nodes) to process the transaction from mobile device 124. In this example, mobile device 124 can provide a customer code, credit card information, and/or other related payment or authorization information (e.g., via QR code, NFC field, etc.) to handheld 106, which handheld 106 can utilize in communicating with bank(s) 122 to process the transaction directly. In addition, in this example, handheld 106 can be a payment server for multiple handhelds at retail site 102, such that payment information at the other handhelds can be received from mobile devices and passed through to handheld 106 (e.g., via WiFi 110, FCC 108, or other connections) for processing with bank(s) 122.

Further in an example, handheld 106 can obtain the customer code from mobile device 124 and provide the customer code with transaction information to the mobile payment server 114. The mobile payment server 114 can use this information to coordinate payment with the mobile device 124 based on customer code. In one example, mobile payment server 114 can communicate with an application on mobile device 124 upon receiving the transaction information from handheld 106 to initiate the payment process, and mobile device 124 can process payment based on user input or otherwise. In one example, as described, mobile device 124 can display the customer code as a QR code, bar code, etc., or otherwise render as a NFC field, Bluetooth communication, etc. In another example, the customer code can be a QR or bar code printed on the mobile device 124, on a car or other object owned by the mobile device 124 user, etc. In this example, the printed code can be associated with the customer code in another database at mobile payment server 114. In one example, the association can be based on mobile device 124 or other device registering the code therewith (e.g., the mobile device 124 scans a QR code on a car of the user, and communicates the QR code or related information to mobile payment server 114 for associating to mobile device 124 or an identifier thereof). Thus, handheld 106 can scan or image the printed code at payment time (e.g., via an integrated scanner, camera, etc.), and can provide the customer code with transaction information, as described. In similar examples, it is to be appreciated that the car or other object owned by the mobile device 124 user can provide the customer code in an NFC field, Bluetooth communication, etc., consumable by handheld 106.

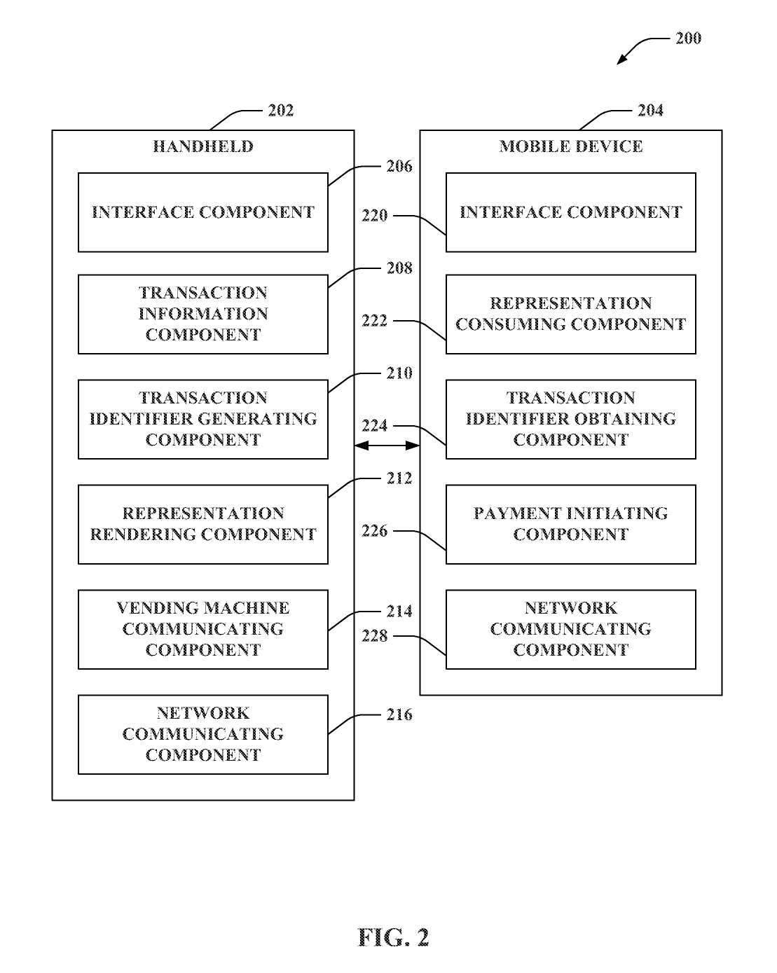

FIG. 2 illustrates an example system 200 for processing mobile payments for vending transactions. System 200 can include a handheld 202 for an attendant present at a vending machine, and a mobile device 204 that communicates therewith to process mobile payment for goods or services dispensed at the vending machine. Handheld 202 can be a device operated by the attendant to process instructions related to one or more vending machines. For example, in this regard, handheld 202 can communicate with the vending machine (e.g., via a FCC) and/or other devices. Mobile device 204 can be substantially any device that allows a customer to communicate with handheld 202 and/or with other devices via other networks (e.g., a mobile network, a WiFi network, etc.). Thus, handheld 202 and mobile device 204 can include one or more processors for executing instructions relating to various components described herein, memory for storing such instructions or information related thereto, interfaces for facilitating user interaction, or other components found in similar devices.

Handheld 202 can include an interface component 206 for receiving input from or outputting data to an attendant of a vending machine, a transaction information component 208 for obtaining data regarding a transaction with the vending machine, a transaction identifier generating component 210 for creating and/or communicating a transaction identifier related to the transaction with the vending machine, and a representation rendering component 212 for generating a representation of the transaction identifier that is consumable by a mobile device. Handheld 202 also includes a vending machine communicating component 214 for communicating with one or more vending machines over one or more networks or related devices, and a network communicating component 216 for communicating with one or more other devices via a local area network, the Internet, etc.

Mobile device 204 can include an interface component 220 for receiving input from or outputting data to user, a representation consuming component 222 for obtaining a representation of a transaction identifier from a handheld at a vending machine, a transaction identifier obtaining component 224 for determining the transaction identifier from the representation, and a payment initiating component 226 for initiating a mobile payment for a transaction related to the transaction identifier. Mobile device 204 also includes a network communicating component 228 for communicating with one or more other devices over one or more networks.

Handheld 202 can operate in conjunction with a vending machine, as described, and vending machine communicating component 214 allows attendant operation of at least some processes of the vending machine via handheld 202. For example, vending machine communicating component 214 communicates with the vending machine over a FCC, Bluetooth, or other connection to the vending machine. According to an example, interface component 206 can present various options to an attendant of the vending machine to communicate with or on behalf of the vending machine. In one example, the interface component 206 can allow the attendant to process payments for items dispensed by the vending machine. Thus, once goods or services are dispensed or at least engaged to begin dispensing, interface component 206 can display or otherwise allow selection of an option to process payment for the goods or services. When this option is selected (e.g., by an attendant at the vending machine), transaction information component 208 can obtain information regarding the transaction from the vending machine, such as items purchased, purchased price (e.g., total purchase price, purchase price per units with a number of units purchased, . . . ), an identifier of the vending machine, the service station related to the vending machine, etc.

Transaction identifier generating component 210 can create a transaction identifier. In one example, the transaction identifier can be created based on at least a portion of the transaction information. The transaction identifier can be a string representation of the transaction information, one or more hash values related to the transaction information, a unique identifier that can be associated to the transaction information at handheld 202, etc. In this regard, the transaction identifier can be unique to the transaction information. In one example, transaction identifier generating component 210 can communicate the transaction identifier and/or related transaction information to a mobile payment server, as described above, to allow a customer's mobile device to initiate mobile payment of the transaction based on the transaction identifier. This can be accomplished via network communicating component 216 transmitting the transaction identifier and/or related information to the mobile payment server (e.g., over a WiFi or other connection to one or more networks providing a path to access the mobile payment server). In another example, the transaction identifier can include information such as a retail site identifier, vending machine number, transaction number, etc., to allow a mobile payment server to connect to the retail site to obtain remaining transaction information upon receiving the transaction identifier from mobile device 204.

In one example, as described, before generation of the transaction identifier, network communicating component 216 can communicate transaction information received from transaction information component 208 to a third party server (e.g., via a mobile payment server or otherwise) for authorizing/denying the transaction for mobile device 204. This can be part of a prepayment or post-payment process, and in the former example, network communicating component 216 can receive a transaction maximum approved by the third party server. Handheld 202 can use this transaction maximum in communicating with the vending machine via vending machine communicating component 214, in one example (e.g., to specify an amount of dispensing allowed). In one example, handheld 202 can determine to communicate the transaction information based on one or more aspects of mobile device 204, such as an identifier or type thereof, a credit card used by a mobile payment application, instructions received from mobile payment server based on provided transaction information, etc.

Representation rendering component 212 can then generate one or more representations of the transaction identifier for consumption by one or more mobile devices to process payment for the transaction. For example, this can be performed based on a command issued via interface component 206 (e.g., a mobile payment command). In one example, representation rendering component 212 can generate and/or display (e.g., on a display of handheld 202) a QR code, bar code, numeric identifier, etc. that is representative of the transaction identifier. In one example, the QR code, bar code, etc. can be generated by the mobile payment server based on the transaction information, and can be provided to the handheld 202 for rendering. Representation consuming component 222 of mobile device 204 can obtain the representation from handheld 202. In one example, representation consuming component 222 can include or can utilize a camera or scanner integrated with mobile device 204 to read the QR code, bar code, numeric identifier, etc. In another example, interface component 220 can be used to manually enter the transaction identifier or representative numeric code into mobile device 204.

It is to be appreciated that the transaction identifier can be a long string, and the longer the string, the more unique possibilities. Thus, the transaction identifier in many cases can represent the retail site, a vending machine number, a transaction number on the vending machine, etc., and a QR code or bar code can allow for encoding such strings or unique representations thereof for associating by a mobile payment server. Where interface component 220 renders a numeric code for manual entry at the mobile device 204 (e.g., in a payment application, a phone call to a mobile payment provider, a short message service (SMS) message, etc.), a shorter string that correlates to the transaction identifier may be more desirable to avoid entry errors. In this example, transaction identifier generating component 210 can request the numeric code from the mobile payment server, which can act as a central repository for the numeric codes, generating unique codes for each transaction, and associating the codes with received transaction information. In this regard, for example, transaction identifier generating component 210 can receive the numeric code in response to transaction information component 208 providing the transaction information to the mobile payment server.

In another example, representation rendering component 212 can generate an NFC field that indicates the transaction identifier, or other wireless signals for communicating the transaction identifier, such as a Bluetooth signal, ZigBee, etc. In this example, representation consuming component 222 can receive the field or wireless signal via an integrated receiver when within a proximity of handheld 202. In one example, this can include network communicating components 216 and 228 establishing a wireless connection, as described, to facilitate additional communications. In any case, representation consuming component 222 can obtain the representation based on an application executing on the mobile device 204. In one example, interface component 220 can receive a command (e.g., based on user input) to execute the application and/or initiate receipt of the representation from the handheld 202. For example, interface component 220 can receive a command to read the QR code, bar code, etc. where presented by the handheld 202. In another example, an application on mobile device 204 allows for automatic discovery and processing of the wireless signal representations.

Various other representations can be used as well, and the above and below examples are not exhaustive. For example, representation rendering component 212 can audibly render the transaction identifier or related numeric value, such as by using a digitized voice or other tones representing numeric or alphanumeric values, etc., and representation consuming component 222 can include a microphone that receives and processes the audio to obtain the transaction identifier. In other examples, representation rendering component 212 can cause rendering to occur on separate devices at the retail site. For example, this can include a rendering on a screen at the service station or at the vending machine, from which the representation consuming component 222 can image the representation, and/or from which the user can read and input the representation using interface component 220. In another example, the remote rendering can involve activating a NFC, Bluetooth, or other wireless communication from the vending machine for consumption by mobile device 204. In yet another example, representation rendering component 212 can include the transaction identifier or a related value in a SMS message to the mobile device 204. In this example, the mobile device 204 can provide its phone number to the retail site (e.g., by dialing an 800 number or otherwise advertising via wireless signal) for receiving the SMS message.

In any case, transaction identifier obtaining component 224 can determine a transaction identifier based on the representation. For example, the representation can indicate the transaction identifier in a field thereof, and/or can include instructions for obtaining the transaction identifier. Payment initiating component 226 can initiate payment for the transaction based on the transaction identifier (e.g., by transmitting the identifier and/or additional information to a mobile payment server), and can receive a confirmation or rejection of the payment, as described. As described, the mobile payment server determines transaction information that correlates to the transaction identifier, and processes payment based on the transaction information. In one example, interface component 220 can display a receipt where the payment is confirmed. For example, payment initiating component 226 can communicate the transaction identifier or other information to the mobile payment server via network communicating component 228.

Moreover, in an example, interface component 220 can display information regarding the transaction on mobile device 204 for authorization by the user. The information can come from handheld 202 as part of the representation rendering for the transaction identifier, and/or can come from the mobile payment server based on providing the transaction identifier thereto. In the latter example, the information can be that previously provided by the handheld 202 for the transaction. In any case, the information (e.g., payment amount, service station to which the payment is submitted, etc.) can be authorized using interface component 220.

In another example, mobile device 204 can dial a number corresponding to the vending machine (e.g., a number displayed thereon or provided by the attendant), or enter the number in the mobile application via interface component 220 to indicate that dispensing of goods from the vending machine is desired. Once the handheld 202 authorizes the transaction, the transaction information can be displayed by interface component 220, which can offer options for approval by the user of the mobile device 204. Once approved, mobile payment processing occurs, as described above.

Handheld 202 can allow prepayment of goods as well. For example, interface component 206 can specify an option for prepayment, and transaction information component 208 can obtain the related transaction information. In one example, this can be input via interface component 206 (e.g., a prepayment amount). In another example, the prepayment information can be conveyed by mobile device 204 (e.g., via entry in interface component 220, which can result in generation of a QR code, NFC field, etc., as described below with respect to a customer code). Transaction identifier generating component 210 can generate the transaction identifier for the prepayment transaction based on the prepayment information, and representation communication between handheld 202 and mobile device 204 occurs, as described above, to facilitate mobile payment processing. Once approval is received at handheld 202, handheld 202 can authorize dispensing from the vending machine.

In another example, mobile device 204 can present a customer code that handheld 202 can scan to process the payment. In this example, mobile device 204 may include a similar component as representation rendering component 212 to provide the customer code to the handheld 202 (e.g., via QR code, bar code, numeric identifier, NFC field, Bluetooth or other wireless communication, etc.), and handheld 202 may include a component similar to representation consuming component 222 to obtain the representation and determine the customer information. In another example, the customer code can be printed on or otherwise provided by another object owned by the user of mobile device 204 (e.g., on the user's car), and can be accordingly consumed by handheld 202. In either case, transaction information component 208 can provide the customer code along with other transaction specific information to a mobile payment server to process payment, as described. This can be used where handheld 202 implements the mobile payment server, in one example.

In a specific example, mobile device 204 can execute an application ready to communicate with handheld 202, when handheld 202 scans the QR code, bar code, etc. representative of the customer code, and transaction information component 208 provides the customer code to the mobile payment server. Thus, the mobile payment server can associate the customer code with mobile device 204 based on a previous registration of the customer code to mobile device 204 (e.g., based on mobile device 204 scanning the code and providing to the mobile payment server). In this example, the mobile payment server can contact handheld 202 via network communicating component 216 to indicate that mobile payment has been requested of mobile device 204, and the mobile payment server can contact mobile device 204 to request approval of the payment via network communicating component 228. Payment initiating component 226 can accordingly initiate the payment, and mobile payment server can continue processing the payment, as described above.

Furthermore, handheld 202 can process multiple transactions at multiple stages at a given point in time. Thus, for example, interface component 206 can approve dispensing in one transaction, while representation rendering component 212 can generate a transaction identifier or representation for another transaction. Additionally, handheld 202 can be used to operate a plurality of vending machines at one or more retail sites and process related transactions. For example, for a given transaction, the interface component 206 can allow selection of a specific vending machine and the transaction on the vending machine. Based on the selection, the interface component 206 can provide an option to authorize dispensing, check status of dispensing, process payment for the transaction, which can cause gathering of transaction information, generation of the transaction identifier and/or representation, communication of the information, identifier, and/or representation to the mobile payment server, etc.

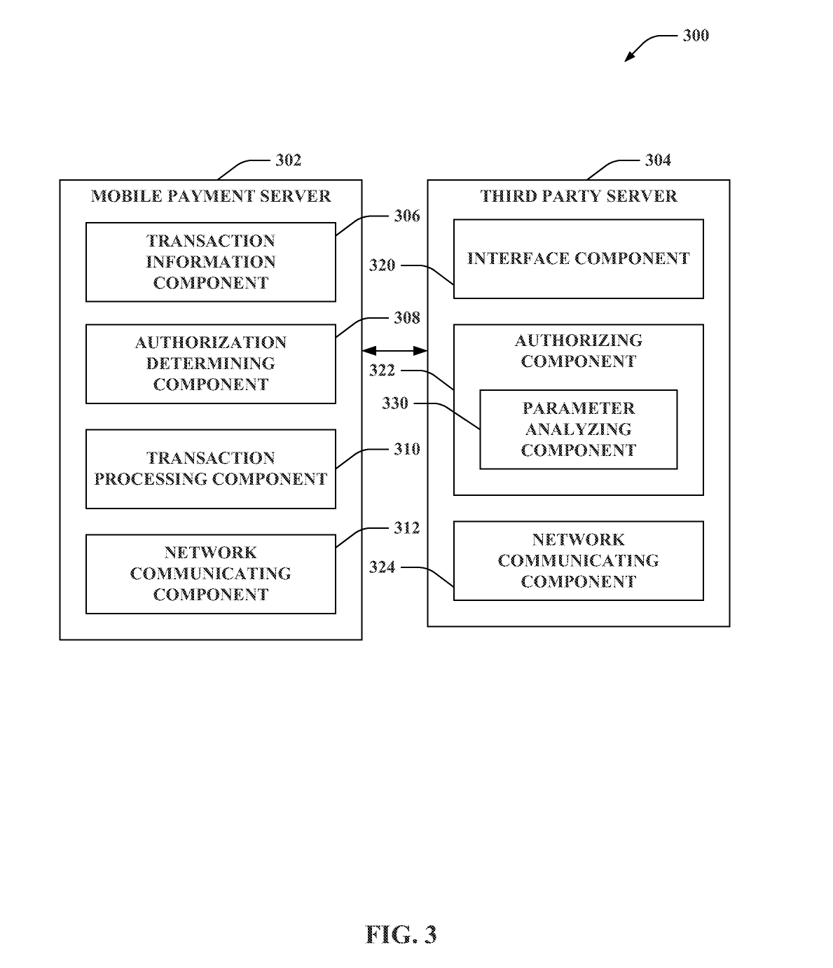

FIG. 3 illustrates an example system 300 that facilitates mobile payment processing involving third party authorization. System 300 includes a mobile payment server 302 for processing mobile payments for vending machine transactions, and a third party server 304 for authorizing mobile payments based on one or more parameters of the transactions. For example, mobile payment server 302 can be similar to mobile payment server 114, and third party server 304 can be similar to third party server 130, as described above. Mobile payment server 302 and third party server 304 can communicate over the Internet or other network connection, and/or can communicate with other components not shown to simplify explanation.

Mobile payment server 302 can include a transaction information component 306 for obtaining transaction information from a handheld or other device at a retail site for processing mobile payment thereof, an authorization determining component 308 for determining whether third party authorization is needed for the transaction, a transaction processing component 310 for processing mobile payment for the transaction, and a network communicating component 312 for communicating with one or more servers, devices, etc., over one or more networks.

Third party server 304 includes an interface component 320 for receiving information from a user or programmatic entity, or rendering information thereto, an authorizing component 322 for authorizing a transaction for a mobile device based on received transaction information, and a network communicating component 324 for communicating with one or more servers, devices, etc. over one or more networks. Authorizing component 322 can include a parameter analyzing component 330 for evaluating one or more parameters related to received transaction information or related to additional aspects in determining whether to authorize payment for the transaction related to the mobile device.

According to an example, transaction information component 306 can obtain transaction information from a handheld, POS, etc. at a retail site, as described. In one example, mobile payment server 302 can be part of a handheld, and thus can generate the transaction information based on communicating with a vending machine, such as a fuel dispenser, at the retail site. The transaction information relate to a mobile device and/or processing a mobile payment for a transaction, and can include one or more parameters related to a transaction at the retail site, such as a transaction identifier, a price, amount dispensed and price per unit, retail site identifier, retail site or transaction type, fuel dispenser identifier, etc. Transaction information component 306 can store the transaction information for subsequent processing based on receiving a mobile payment initiation from the mobile device specifying the transaction identifier. In another example, where handheld initiates the payment for the mobile device, transaction information component 306 can also receive one or more parameters related to a mobile device for the transaction from the handheld, such as a customer code or other information receivable by the handheld, as described.

In either case, once the transaction information and mobile device are identified, authorization determining component 308 can communicate with third party server 304 to determine whether the mobile device (or related application, credit card presented by the application, etc.), is authorized to pay for the transaction. In an example, authorization determining component 308 can initially query one or more databases to determine whether third party authorization is necessary for the mobile device. In response, the authorization determining component 308 can obtain an indication as to whether such authorization is necessary and/or instructions or at least a network address for querying the appropriate third party server, such as third party server 304. Where authorization determining component 308 receives an indication that the mobile device is authorized to pay for the transaction, transaction processing component 310 can continue processing the mobile payment, as described.

In an example, authorization determining component 308 can determine whether third party authorization is necessary for a given mobile device or a given transaction. For instance, mobile payment server 302 can receive an indication of required authorization from the mobile device (or a mobile payment application operating on the mobile device), from the third party server 304, from a network service provider of the mobile device, etc. In addition, the indication can relate to the mobile device (e.g., to an identifier thereof), to a credit card or other payment that can be utilized by the mobile device, etc., and the indication and identifier can be stored in one or more databases accessible by authorization determining component 308.

In another example, transaction information component 306 can receive an indication in the transaction information from the handheld that authorization is required for the specific transaction. For example, the handheld can acquire the information based on an indication from the mobile device (e.g., upon processing a customer code received from the mobile device), based on a type of the mobile device, a type of credit card (e.g., a company card) or other payment presented by the mobile device, or information presented on the credit card, etc. In any case, authorization determining component 308 can store the indication for the given transaction.

Authorization determining component 308 can communicate with the third party server 304 via network communicating component 312 to determine authorization for the mobile device. Where the indication includes an address of third party server 304, authorization determining component 308 can contact the server 304 based on the address. It is to be appreciated, however, that the indication may include other information from which an identification of the appropriate third party server can be determined by authorization determining component 308. In any case, network communicating component 324 can receive the authorization request from mobile payment server 302, which can include an identifier of a mobile device or related payment (e.g., a credit card number), and/or other transaction processing information.

Authorizing component 322 can determine whether to authorize payment for the mobile device. In one example, interface component 320 can allow for manual specification of whether to authorize the transaction. For example, authorizing component 322 can cause interface component 320 to display or otherwise communicate an authorization request to another device (e.g., a mobile device of an authorized employee of a corporation), and the request can include the transaction details and information related to the mobile device requesting payment (or related payment information, such as a credit card number, or name on the credit card), etc. Interface component 320 can receive an authorization specification in this example (e.g., from an operator of the third party server 304), and can notify authorizing component 322 whether the transaction is authorized or denied.

In another example, authorization component 322 can determine whether to authorize the transaction based on one or more parameters in the transaction information or otherwise. For example, parameter analyzing component 330 can evaluate parameters such as a transaction price, transaction type, mobile device or related payment information presented, a location of the mobile device (e.g., received in transaction information from the retail site, received from the mobile device based on a request or tracking device, etc.), a time of day, a customer code (e.g., which can be present on a car or other object owned by a corporation), etc. If certain conditions defined for the parameters are satisfied, authorizing component 322 can authorize or otherwise deny the transaction. In one example, third party server 304 can allow specification of the parameters and related conditions for authorization to be input via interface component 320 (e.g., an operator can specify that transactions of a certain type for certain mobile devices can be authorized during certain times of day, days of a week, etc.). In other examples, it is to be appreciated that programs or scripts can be executed, using interface component 320 as an application programming interface (API), to formulate desired parameter checking to determine authorization, to involve determinations at additional servers in the corporate network, etc.

In any case, authorizing component 322 can communicate an authorization or denial to mobile payment server 302 via network communicating component 324. Authorization determining component 308 can receive authorization or denial, and can accordingly determine whether to continue with payment processing or indicate denial to the handheld.

In another example, where the handheld processes prepayment for a transaction, transaction information component 306 can obtain a customer code, mobile device identifier, payment type or information (e.g., credit card number, etc.) or other information related to the mobile device, as described. Authorization determining component 308 can similarly locate third party server 304 as related to the mobile device, as described above, and can transmit the transaction information thereto. In this example, authorizing component 322 can determine whether to authorize prepayment and/or an amount to authorize based on the transaction information. The determination can be based on similar parameters and conditions, as described above (e.g., a condition allowing for a certain prepayment authorization amount for certain devices for certain transaction types at given times of day, on given days of the week, etc.). Authorizing component 322 can communicate prepayment approval and/or amount to the mobile payment server 302, which can store such for later transaction payment processing. In addition, authorization determining component 308 can communicate the information from third party server 304 to the handheld, and the handheld can use this information for determining how to dispense goods to the mobile device (e.g., only dispense goods that are less than or equal to a maximum approved transaction amount).

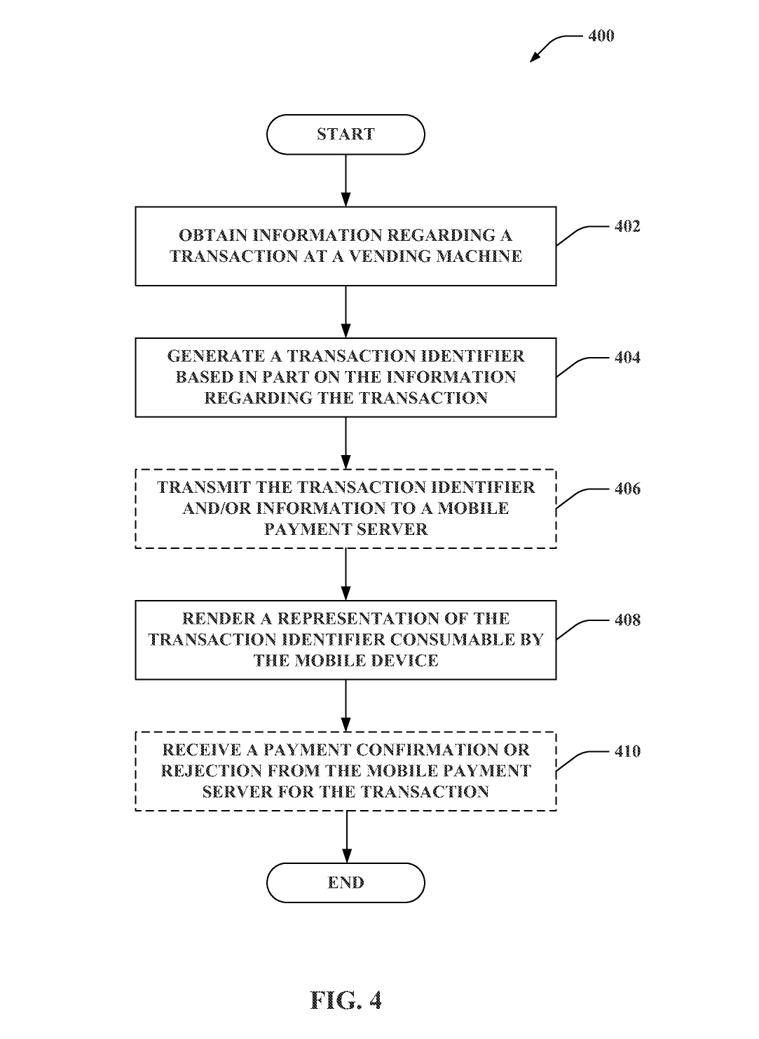

Referring to FIGS. 4-6, methodologies that can be utilized in accordance with various aspects described herein are illustrated. While, for purposes of simplicity of explanation, the methodologies are shown and described as a series of acts, it is to be understood and appreciated that the methodologies are not limited by the order of acts, as some acts can, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

FIG. 4 illustrates an example methodology 400 for generating information for one or more transactions at one or more vending machines. At 402, information regarding a transaction at a vending machine can be obtained. For example, the information can be requested from the vending machine based on a request to obtain the information (e.g., specified by an attendant on a provided user interface). In one example, the request can specify a customer or related mobile device identifier where the vending machine hosts multiple transactions over a short period of time. The information can include a cost of the transaction—which can be a total cost, a cost per unit along with a number of units dispensed, and/or the like—a vending machine identifier, service station information at which the vending machine resides, etc.

At 404, a transaction identifier can be generated based in part on the information regarding the transaction. For example, the transaction identifier can be a string representation of at least a portion of the transaction information, a hash value or other function of the information, a generated random or unique identifier, an identifier related to a vending machine or service station for the transaction, or similar identifiers that can allow association of the transaction information for subsequent retrieval based on the identifier.

At 406, the transaction identifier and/or information regarding the transaction are optionally transmitted to a mobile payment server. For example, the mobile payment server can be accessible over the Internet, VPN, etc., and can associate the transaction identifier with the information for subsequent retrieval in mobile payment processing. In other examples, where the transaction identifier correlates to the vending machine, the mobile payment server can access the vending machine to obtain transaction information when a transaction identifier is received from a mobile device.

At 408, a representation of the transaction identifier that is consumable by the mobile device can be rendered. As described, this can include printing or displaying a visual representation of the transaction identifier as a QR code, bar code, numeric identifier, and/or the like (e.g., on paper or a display). In another example, this can include activating a NFC field, Bluetooth, or other wireless communication that indicates the transaction identifier. In either case, the mobile device can image the code, receive the field or communication, or otherwise cause entry of a numeric identifier for determining the transaction identifier to provide to the mobile payment server in processing the appropriate payment.

At 410, a payment confirmation or rejection is optionally received from the mobile payment server for the transaction. In this example, the confirmation, rejection, etc. can be displayed at a handheld or otherwise rendered thereto to indicate whether the payment is successful.

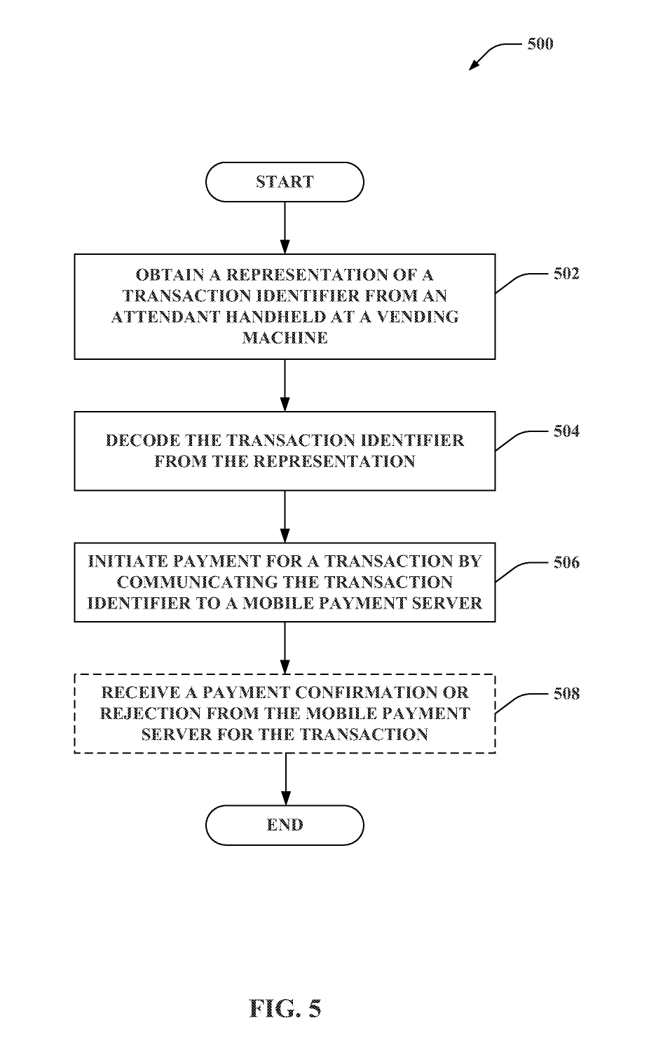

FIG. 5 illustrates an example methodology 500 for initiating mobile payment of a transaction at an attended vending machine. At 502, a representation of a transaction identifier can be obtained from an attendant handheld at a vending machine. The representation, as described, can be a printed or displayed code (e.g., a QR code, bar code, etc.), a wireless communication (e.g., NFC field, Bluetooth communication, etc.), and/or the like. Thus, the representation can be obtained based on at least one of imaging the representation, being within a proximity of the handheld communicating the representation, and/or the like.

At 504, the transaction identifier can be decoded from the representation. In one example, this can be performed by an application that processes the representation to obtain data therefrom, such as a QR or bar code reader application, a NFC communication application, etc. The transaction identifier can be embedded within the representation or otherwise obtainable from information received in the representation, and/or the like.

At 506, payment for a transaction is initiated by communicating the transaction identifier to a mobile payment server. Using the transaction identifier, as described, the mobile payment server can obtain other information for processing payment for the transaction. For example, the mobile payment server matches the transaction identifier to a transaction at a vending machine from which the transaction identifier was received. Payment initiation can also include communicating payment methods to the mobile payment server, or selecting a payment method stored thereon.

At 508, a payment confirmation or rejection can optionally be received from the mobile payment server for the transaction. Thus, a receipt can be sent to the customer's mobile device, or the mobile payment can be canceled, reinitiated, etc. based on receiving the confirmation or rejection, in one example.

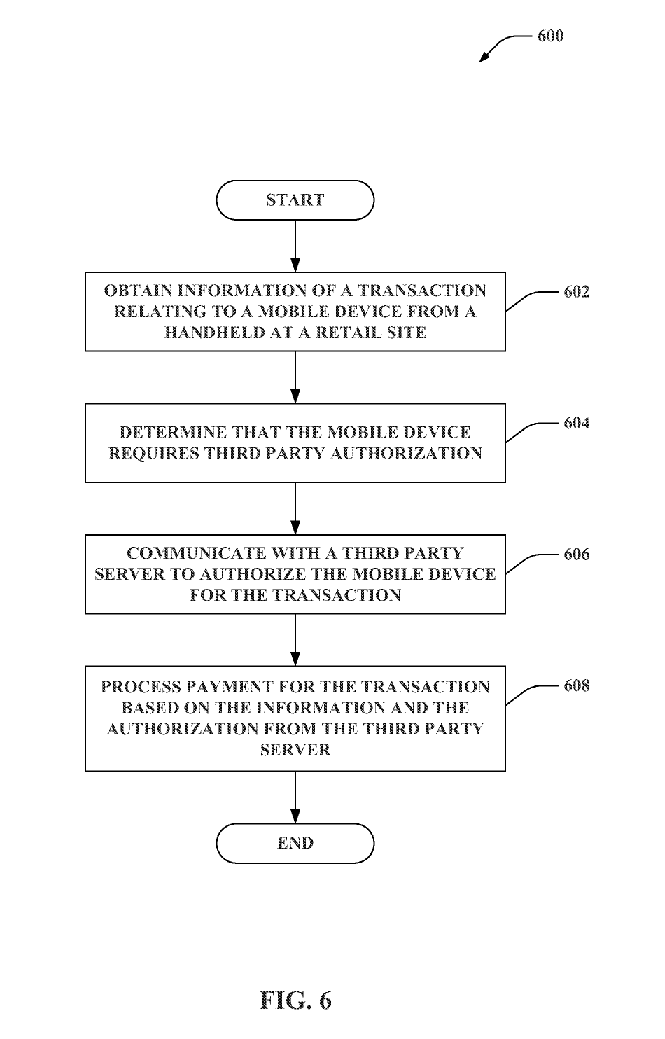

FIG. 6 illustrates an example methodology 600 for processing mobile payment for a transaction with third party authorization. At 602, information of a transaction related to a mobile device can be obtained from a handheld at a retail site. For example, the information can include a transaction identifier, a mobile device identifier, a transaction amount or type, a retail site identifier, etc. The information can be obtained via a connection with the handheld (e.g., via an Internet connection, a connection with a corresponding retail site, etc.).

At 604, it can be determined that the mobile device requires third party authorization. In one example, an indication of such can be received with the information relating to the transaction. In another example, this can be determined based in part on querying one or more databases or data stores based on the mobile device identifier or an identifier of the payment (e.g., credit card number) to determine whether authorization is required. In either case, in an example, the response can include information regarding a third party server that provides the authorization.

At 606, the third party server can be communicated with to authorize the mobile device for the transaction. This can include transmitting at least a portion of the information regarding the transaction to the third party server. As described, in an example, the third party server can evaluate this information with other parameters, such as location of the mobile device, time of day, etc., to determine whether to authorize the transaction. The third party server can provide an authorization or denial based on the information, as described.

At 608, payment for the transaction can be processed based on the information and the authorization from the third party server. Thus, where the mobile device is authorized, payment processing continues at 608. This can include contacting a bank related to the mobile device or a payment method presented by the mobile device to authorize the transaction.

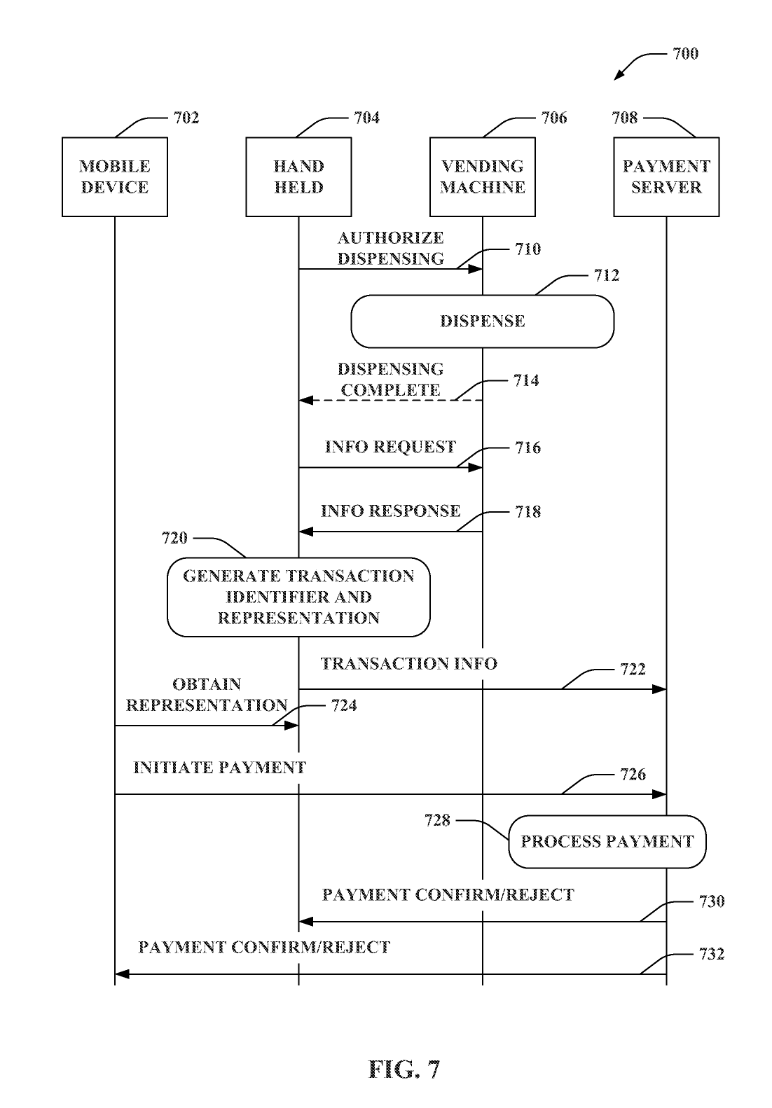

FIG. 7 illustrates an example system 700 for processing a transaction at an attended vending machine. System 700 includes a mobile device 702, which can be similar to mobile devices 124 and 204, handheld 704, which can be similar to handhelds 106 and 202, vending machine 706, which can be similar to vending machine 104, and payment server 708, which can be similar to mobile payment server 114.

In this example, handheld 704 can authorize dispensing 710 at vending machine 706. This can include interacting with handheld 704 to send an authorization communication to the vending machine 706 (e.g., via a FCC, Bluetooth or other wireless communication, etc.). Vending machine 706 can accordingly dispense 712 goods or services, and can optionally notify handheld 704 when dispensing is complete 714, which can indicate the end of a transaction. As described above, it is to be appreciated that the next steps could also occur prior to dispensing in a prepayment scenario.

Handheld 704 can request transaction information 716 from vending machine 706 following the dispensing, including a total price of what was dispensed, a unit price and number of units dispensed, etc. Vending machine 706 can provide the requested information 718 to handheld 704. In one example, it is to be appreciated the vending machine 706 can automatically provide this information to handheld 704 once dispensing is complete (e.g., as part of an indication that dispensing is complete). Handheld 704 can generate a transaction identifier and representation thereof 720 based on the transaction information to allow mobile device 702 to initiate payment for the transaction. As described, the transaction identifier can be associated with or can otherwise include transaction information, or information regarding the vending machine so that payment server 708 can subsequently obtain the transaction information.

In this regard, handheld 704 can transmit transaction information 722 to payment server 708, which can store the transaction information for processing mobile payments. The transaction information can include the transaction identifier, transaction cost, etc. Mobile device 702 can obtain the representation of the transaction identifier 724, as described. This can include imaging or scanning a QR or bar code (e.g., a QR code generated on the display of handheld 704), receiving an NFC or other communication, etc., and the mobile device 702 can communicate the transaction identifier from the representation to the payment server 708 in initiating payment 726. Payment server 708 processes the payment 728 based on the transaction identifier and other information received from the mobile device 702 (e.g., at the time of the payment initiation 726 or earlier), such as credit card information. This can include contacting a third party server (not shown) for authorization of the payment, as described. Payment server can communicate a payment confirmation or rejection 730 to handheld 704, and a payment confirmation or rejection 732 to mobile device 702.

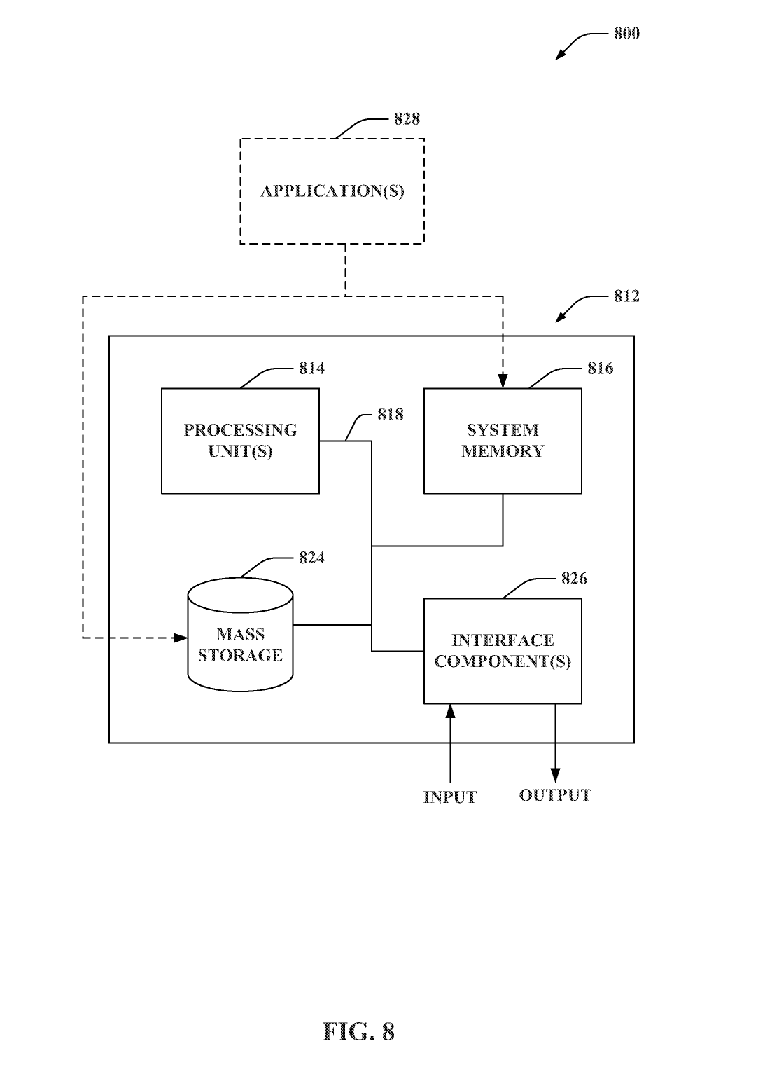

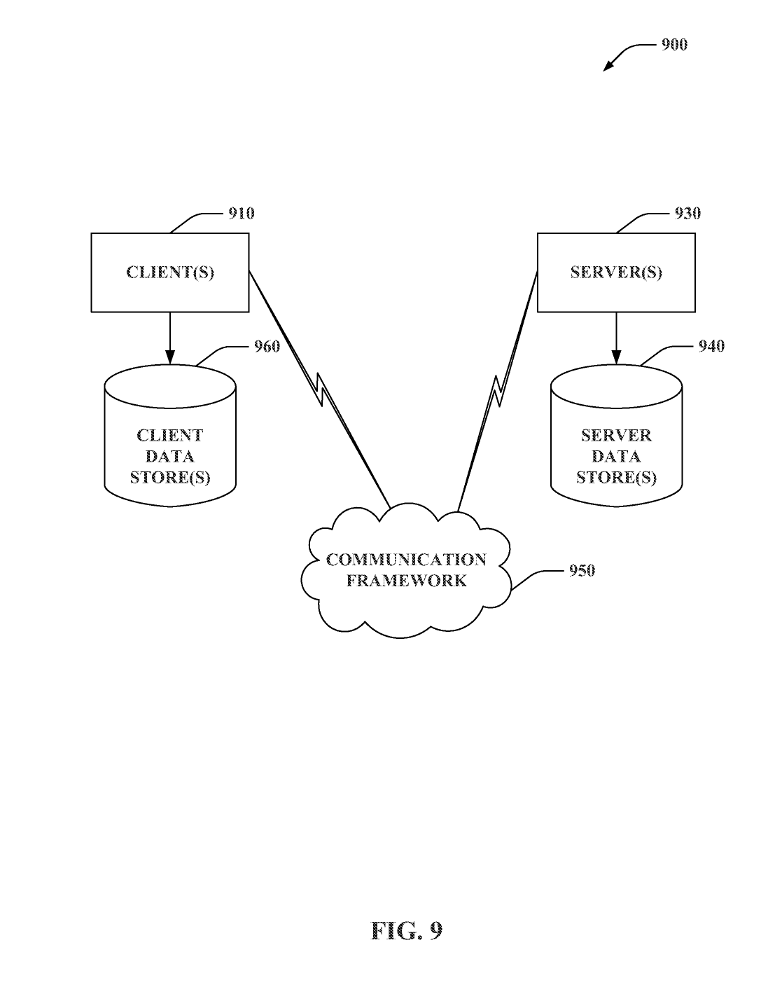

To provide a context for the various aspects of the disclosed subject matter, FIGS. 8 and 9 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 8, an exemplary environment 800 for implementing various aspects disclosed herein includes a computer 812 (e.g., desktop, laptop, server, hand held, programmable consumer or industrial electronics . . . ). The computer 812 includes a processing unit 814, a system memory 816 and a system bus 818. The system bus 818 couples system components including, but not limited to, the system memory 816 to the processing unit 814. The processing unit 814 can be any of various available microprocessors. It is to be appreciated that dual microprocessors, multi-core and other multiprocessor architectures can be employed as the processing unit 814.

The system memory 816 includes volatile and nonvolatile memory. The basic input/output system (BIOS), containing the basic routines to transfer information between elements within the computer 812, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 812 also includes removable/non-removable, volatile/non-volatile computer storage media. FIG. 8 illustrates, for example, mass storage 824. Mass storage 824 includes, but is not limited to, devices like a magnetic or optical disk drive, floppy disk drive, flash memory or memory stick. In addition, mass storage 824 can include storage media separately or in combination with other storage media.

FIG. 8 provides software application(s) 828 that act as an intermediary between users and/or other computers and the basic computer resources described in suitable operating environment 800. Such software application(s) 828 include one or both of system and application software. System software can include an operating system, which can be stored on mass storage 824, that acts to control and allocate resources of the computer system 812. Application software takes advantage of the management of resources by system software through program modules and data stored on either or both of system memory 816 and mass storage 824.

The computer 812 also includes one or more interface components 826 that are communicatively coupled to the bus 818 and facilitate interaction with the computer 812. By way of example, the interface component 826 can be a port (e.g., serial, parallel, PCMCIA, USB, FireWire . . . ) or an interface card (e.g., sound, video, network . . . ) or the like. The interface component 826 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 812 to output device(s) via interface component 826. Output devices can include displays (e.g., cathode ray tube (CRT), liquid crystal display (LCD), light emitting diode (LCD), plasma . . . ), speakers, printers and other computers, among other things.

According to an example, the processing unit(s) 814 can comprise or receive instructions related to processing mobile payments, determining whether to engage third party authorization for a mobile device, etc., and can receive related information from or provide related information to an interface component 826 (which can include an interface component, such as interface component 104), and/or other aspects described herein. It is to be appreciated that the system memory 816 can additionally or alternatively house such instructions and the processing unit(s) 814 can be utilized to process the instructions. Moreover, the system memory 816 can retain and/or the processing unit(s) 814 can comprise instructions to effectuate updating of the directory objects to ensure replication with one or more additional operating environments, for example.

FIG. 9 is a schematic block diagram of a sample-computing environment 900 with which the subject innovation can interact. The environment 900 includes one or more client(s) 910. The client(s) 910 can be hardware and/or software (e.g., threads, processes, computing devices). The environment 900 also includes one or more server(s) 930. Thus, environment 900 can correspond to a two-tier client server model or a multi-tier model (e.g., client, middle tier server, data server), amongst other models. The server(s) 930 can also be hardware and/or software (e.g., threads, processes, computing devices). The servers 930 can house threads to perform transformations by employing the aspects of the subject innovation, for example. One possible communication between a client 910 and a server 930 may be in the form of a data packet transmitted between two or more computer processes.

The environment 900 includes a communication framework 950 that can be employed to facilitate communications between the client(s) 910 and the server(s) 930. Here, the client(s) 910 can correspond to program application components and the server(s) 930 can provide the functionality of the interface and optionally the storage system, as previously described. The client(s) 910 are operatively connected to one or more client data store(s) 960 that can be employed to store information local to the client(s) 910. Similarly, the server(s) 930 are operatively connected to one or more server data store(s) 940 that can be employed to store information local to the servers 930.

By way of example, one or more clients 910 can request mobile payment processing for a transaction to the server(s) 930 via communication framework 950. The server(s) 930 can leverage the server data store(s) 940 to determine parameters related to the transaction or a related mobile device, process mobile payment for the transaction, etc. The server(s) 930 can obtain the associations and/or related parameters and transmit such back to the client(s) 910 via communication framework 950. The client(s) 910, in one example, can store transaction information in the client data store(s) 960, for example.

The various illustrative logics, logical blocks, modules, components, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above. An exemplary storage medium may be coupled to the processor, such that the processor can read information from, and write information to, the storage medium. In the alternative, the storage medium may be integral to the processor. Further, in some aspects, the processor and the storage medium may reside in an ASIC.

In one or more aspects, the functions, methods, or algorithms described may be implemented in hardware, software, firmware, or any combination thereof. If implemented in software, the functions may be stored or transmitted as one or more instructions or code on a computer-readable medium, which may be incorporated into a computer program product. Computer-readable media includes both computer storage media and communication media including any medium that facilitates transfer of a computer program from one place to another. A storage medium may be any available media that can be accessed by a computer. By way of example, and not limitation, such computer-readable media can comprise random access memory (RAM), read-only memory (ROM), electrically erasable programmable ROM (EEPROM), compact disc (CD)-ROM or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

It can thus be seen that a novel mobile payment system for use at an attended retail site has been disclosed above. While one or more aspects have been described above, it should be understood that any and all equivalent realizations of the presented aspects are included within the scope and spirit thereof. The aspects depicted are presented by way of example only and are not intended as limitations upon the various aspects that can be implemented in view of the descriptions. Thus, it should be understood by those of ordinary skill in this art that the presented subject matter is not limited to these aspects since modifications can be made. Therefore, it is contemplated that any and all such embodiments are included in the presented subject matter as may fall within the scope and spirit thereof.

What is claimed is:

1. A handheld terminal for use in an attended vending environment, comprising:
a transaction information component for obtaining information regarding a transaction at a vending machine;
a transaction identifier component for generating a transaction identifier for the information regarding the transaction; and
a rendering component for rendering a representation of the transaction identifier consumable by a mobile device.

2. The handheld terminal of claim 1, wherein the representation of the transaction identifier is a quick response (QR) code, and the rendering component displays the QR code on a display of the handheld terminal.

3. The handheld terminal of claim 1, wherein the representation of the transaction identifier is a near field communication (NFC) magnetic field, and the rendering component broadcasts the NFC magnetic field.

4. The handheld terminal of claim 1, further comprising an interface component for providing a selectable option for processing a mobile payment, wherein the rendering component renders the representation based on the interface component determining selection of the option for processing the mobile payment.

5. The handheld terminal of claim 4, wherein the transaction information component obtains the information and the transaction identifier component generates the transaction identifier further based at least in part on the interface component determining selection of the option for processing the mobile payment.

6. The handheld terminal of claim 5, further comprising a network communicating component for providing the transaction identifier to a payment server for subsequent processing of payment initiated by the mobile device based at least in part on the interface component determining selection of the option for processing the mobile payment.

7. The handheld terminal of claim 6, wherein the network communicating component communicates the information regarding the transaction to a third party server to receive third party authorization for the transaction.

8. The handheld terminal of claim 6, further comprising a representation consuming component for obtaining a representation of a customer code from the mobile device and determining the customer code from the representation, wherein the network communicating component further provides the customer code to the payment server for processing of the payment.

9. The handheld terminal of claim 1, further comprising an interface component for allowing selection of an option to authorize dispensing at the vending machine, wherein the dispensing correlates to the transaction.

10. The handheld terminal of claim 1, wherein the representation of the transaction identifier is a numeric code displayed on a display of the handheld terminal.

11. The handheld terminal of claim 1, wherein the representation of the transaction identifier is a numeric code sent to the mobile device via short message service (SMS) message.

12. A method for operating a handheld terminal in an attended vending environment, comprising:
utilizing processing circuitry to perform the steps of:
obtaining information regarding a transaction at a vending machine;
generating a transaction identifier for the information regarding the transaction; and
rendering a representation of the transaction identifier consumable by a mobile device.

13. The method of claim 12, wherein the representation of the transaction identifier is a quick response (QR) code, and the rendering comprises displaying the QR code on a display of the handheld terminal.

14. The method of claim 12, wherein the representation of the transaction identifier is a near field communication (NFC) magnetic field, and the rendering comprises broadcasting the NFC magnetic field as a wireless communication.

15. The method of claim 12, further comprising utilizing the processing circuitry to perform the step of providing a selectable option for processing a mobile payment, wherein the rendering is based at least in part on determining selection of the selectable option for processing the mobile payment.

16. The method of claim 15, further comprising utilizing the processing circuitry to perform the step of providing the transaction identifier to a payment server for subsequent processing of payment initiated by the mobile device based at least in part on the determining selection of the option for processing the mobile payment.

17. The method of claim 16, further comprising utilizing the processing circuitry to perform the step of communicating the information regarding the transaction to a third party server to receive third party authorization for the transaction.

18. The method of claim 16, further comprising utilizing the processing circuitry to perform the steps of:
obtaining a representation of a customer code from the mobile device and determining the customer code from the representation; and
providing the customer code to the payment server for processing of the payment.

19. The method of claim 12, further comprising utilizing the processing circuitry to perform the step of allowing selection of an option to authorize dispensing at the vending machine, wherein the dispensing correlates to the transaction.

20. The method of claim 12, wherein the representation of the transaction identifier is a numeric code, and the rendering comprises displaying the numeric code on a display of the handheld terminal.

21. The method of claim 12, wherein the representation of the transaction identifier is a numeric code, and the rendering comprises sending the numeric code to the mobile device via short message service (SMS) message.

22. A system for processing mobile payment for transactions in a vending environment, comprising:
a transaction information component for obtaining information regarding a transaction from a vending machine;
an authorization determining component for communicating with a third party server to authorize the transaction for mobile payment by a mobile device based in part on the information; and
a transaction processing component for processing mobile payment for the transaction based on authorization by the third party server.

23. The system of claim 22, wherein the authorization determining component communicates with the third party server based on determining that authorization is required for the mobile device.

24. The system of claim 23, wherein the authorization determining component determines that the authorization is required for the mobile device based at least in part on the information regarding the transaction.

25. The system of claim 22, wherein the authorization determining component identifies the third party server based on an indication previously received from the mobile device regarding the third party server, or an indication previously received from the third party server regarding the mobile device.

26. A method for processing mobile payment for transactions in a vending environment, comprising:
utilizing processing circuitry to perform the steps of:
obtaining information regarding a transaction from a vending machine;
communicating with a third party server to authorize the transaction for mobile payment by a mobile device based in part on the information; and
processing mobile payment for the transaction based on authorization by the third party server.

27. The method of claim 26, wherein the communicating with the third party server is based on determining that authorization is required for the mobile device.

28. The method of claim 27, wherein the determining that the authorization is required for the mobile device is based at least in part on the information regarding the transaction.

29. The method of claim 26, further comprising utilizing the processing circuitry to perform the step of identifying the third party server based on an indication previously received from the mobile device regarding the third party server, or an indication previously received from the third party server regarding the mobile device
